(19) United States
(12) Patent Application Publication
(10) Pub. No.: US 2022/0180020 A1
(43) Pub. Date: Jun. 9, 2022

(54) A METHOD OF EVALUATING AND/OR OPTIMIZING A MICRO MODEL

(71) Applicant: TOTAL E&P UK LIMITED, Westhill, Aberdeen, Aberdeenshire (GB)

(72) Inventors: Jianhui YANG, Westhill (GB); Enric SANTANACH CARRERAS, Courbevoie (FR); Igor BONDINO, Courbevoie (FR)

(21) Appl. No.: 17/598,827

(22) PCT Filed: Mar. 26, 2019
(86) PCT No.: PCT/GB2019/050859

§ 371 Date: Sep. 27, 2021

(51) Int. Cl. G06F 30/20; G06F 30/10

(52) U.S. Cl. CPC G06F 30/20; G01V 99/005; G06F 30/10

(57) ABSTRACT

Disclosed is a method of evaluating and optimizing a micro model prior to fabrication of the micro model. The method comprises obtaining a design document describing a geometry of a proposed micro model and abstracting the geometry into a simplified representation of said geometry, such as a pore network representation. Performance of the proposed micro model based on the abstracted geometry is simulated and based on this, the proposed micro model is evaluated and/or optimized.

The present disclosure relates to methods for evaluating and/or optimizing a micro model used, for example, in simulating hydrocarbon reservoir flows.

A micro model is a device fabricated in transparent material, such as glass or polymer. It enables the complex flow experiments in a user defined porous structure. For example, such a micro model may be designed to mimic a particular reservoir space (i.e., of a hydrocarbon reservoir). The transparent material enables straightforward observation of flow dynamics within the micro model.

Such micro models are costly to fabricate, with a single model typically costing thousands of pounds. They are also very delicate, and can typically only be used two or three times. As such, a single flow experiment often requires more than one micro model to be produced.

It would be desirable to be able to produce such micro models more simply.

### SUMMARY OF INVENTION

In a first aspect of the invention there is provided a method of evaluating a micro model prior to fabrication of the micro model, the method comprising;

obtaining a design document describing a geometry of a proposed micro model;

abstracting the geometry into a simplified representation of said geometry;

computationally simulating performance of the proposed micro model based on the abstracted geometry; and

evaluating the proposed micro model based on the simulation.

In a second aspect of the invention there is provided a method of fabricating a micro model, the method comprising;

obtaining a design document describing a geometry of a proposed micro model;

abstracting the geometry into a simplified representation;

computationally simulating performance of the proposed micro model based on the abstracted geometry;

evaluating the proposed micro model based on the simulation;

optimizing the micro model by changing the geometry of the proposed micro model and repeating the abstracting, computationally simulating and evaluating steps until a design objective is reached; and

fabricating the optimized micro model.

Other aspects of the invention comprise a computer program comprising computer readable instructions which, when run on suitable computer apparatus, cause the computer apparatus to perform the method of the first aspect; and an apparatus specifically adapted to carry out all the steps of any of the method of the first aspect.

Other non-essential features of the invention are as claimed in the appended dependent claims.

### BRIEF DESCRIPTION OF THE DRAWINGS

Embodiments of the invention will now be described, by way of example only, by reference to the accompanying drawings, in which:

FIG. 1 is an flow diagram of a typical flow experiment performed using a micro model

FIG. 2 is a flowchart of a method according to an embodiment of the invention; and

FIG. 3 shows (a) an exemplary micro model design image and (b) the micro model design image of FIG. 3(a) with extracted pore network overlaid.

### DETAILED DESCRIPTION OF THE EMBODIMENTS

Hydrocarbon reservoir performance simulation comprises the construction and operation of a model having a behaviour which mimics the appearance of actual reservoir behaviour. In some situations, an actual physical model is desired, due to the complexity of the reservoir space geometry being modelled, and the flows within. While computer modelling captures much of the key physics within a reservoir, it has limitations and therefore many final decisions on reservoir management will be made on the basis of a physical simulation.

To perform such a physical simulation, a micro model is typically used. Micro models attempt to physically recreate the reservoir geometry as a micro scale model in, for example, a silicon based glass (which has properties similar to rock). Other materials can be used depending on the objective. The micro model should be transparent, such that when one or more suitably contrasting fluids are introduced, the flow dynamics within the model become visible.

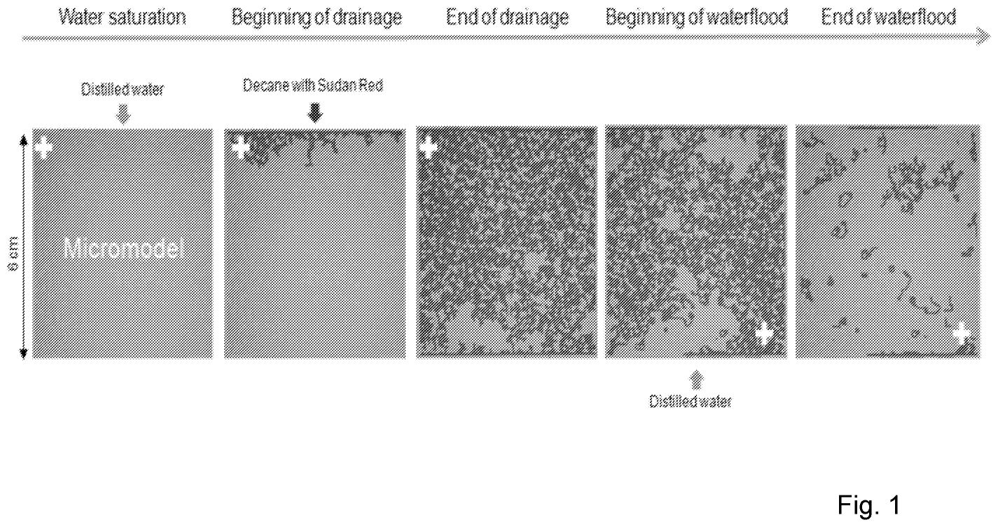

FIG. 1 illustrates a typical, and purely exemplary, experimental method which may be performed using such a micro model. This method comprises a two-phase flow experiment using water and a hydrocarbon (specifically here decane which has been coloured so that it contrasts with the water). In a first step, the water is introduced into the micro model until saturation. The decane is then added and drainage begins. Once drainage ends, the model is again flooded with water to mimic secondary waterflooding. After secondary waterflooding, the residual oil saturation (Sor) in the micro model is measured. To further extract the trapped oil, a simulation of a tertiary injection (Enhanced Oil Recovery EOR), using e.g., thermal, chemical or gas injection techniques, can be performed to evaluate and quantify the reliability and efficiency of designed EOR scheme. The flows within the micro model mimic those within the reservoir, and reservoir decisions can be made based on the observed flows during such an experiment.

As such, micro models have particular application in the evaluation and understanding of EOR process efficiency. When a new chemical for EOR is being evaluated, a micro model can be used to check its efficacy. The advantage of a micro model is that it clearly shows how well the chemical under evaluation displaces the trapped oil. It gives the researcher more information to improve the formula of EOR chemicals. However, it should be appreciated that micro models also have application in evaluation of reservoir processes other than EOR.

Presently, the micro model is fabricated based on a micro model design image (i.e., based on the reservoir geometry). However, evaluating whether the design image is suitable is not necessarily straightforward. It may be that, after fabrication of the micro model at considerable cost, experiment shows that the model does not meet a particular design objective, and therefore is incapable or unsuitable for simulating a desired scenario (e.g., trapped oil portion, velocity distribution etc.). If so, then a new micro model will need to be designed and fabricated.

For example, it may be that, after drainage, a visual check shows that oil is not injected sufficiently uniformly near the inlet region. This is a very common problem for micro models, and can be addressed by adjusting the design of inlet channel size and/or layout to improve the inlet feeding systems, such that micro model experiments are consistent with the real core flood experiment and the real scenario in actual reservoirs (i.e., the oil should be uniformly injected into rock sample).

In another example, after secondary waterflooding, a measurement of Sor from micro model might be compared with real core flooding Sor (if available). If there is an insufficient match, this would indicate that the throat size distribution within the micro model design (by Young-Laplace law, this size controls the capillary entry pressure, which is critical to Sor) and/or the aspect ratio between pore and throat (pore radius divide throat radius) should be varied. A large aspect ratio normally produces more capillary trapping, which increases Sor, or vice versa. Only when the micro model Sor agrees with experimental Sor, can it be assumed that the micro model is a good representation of the reservoir rock.

In a further example, the injecting pressure can be measured during drainage, to obtain a plot of capillary pressure vs saturation. This plot is called a capillary pressure curve, (Pc) which is a good indication of pore size distribution. In the lab, it is possible to measure the capillary pressure curve for a real reservoir sample. If there is a significant discrepancy between micro model Pc and reservoir core Pc, it means the pore size distribution of micro model is not appropriate, and should be changed accordingly.

In each case, according to present methods, none of these issues would have become apparent until the micro model was fabricated and physical tests were performed thereon. As such, a method of designing a micro model is proposed which comprises simulating the micro model's performance, and optimizing its design, before fabrication. Such a method comprises abstracting the micro model design image to a simplified geometry, for example, by using pore network modelling techniques.

A pore network is a simplified geometrical representation of the pore space which preserves the relevant geometric information needed to understand and calculate the flow and transport. The simplification process is typically called pore network extraction. A pore network describes the reservoir geometry in terms of only pores and the connections therebetween. The pores may be assumed to be spherical and therefore defined only by its position, radius, connections (i.e., to which other pores it is connected) and the size/diameter of the connections. Such techniques are described, for example, in “Pore-network extraction from micro-computerized-tomography images”, Dong H and Blunt M J, PHYSICAL REVIEW E 80, 036307 (2009), and “Generalized network modeling: Network extraction as a coarse-scale discretization of the void space of porous media” Raeini A Q Bijeljic B and Blunt M J, PHYSICAL REVIEW E 96, 013312 (2017). Both of these publications are incorporated herein by reference.

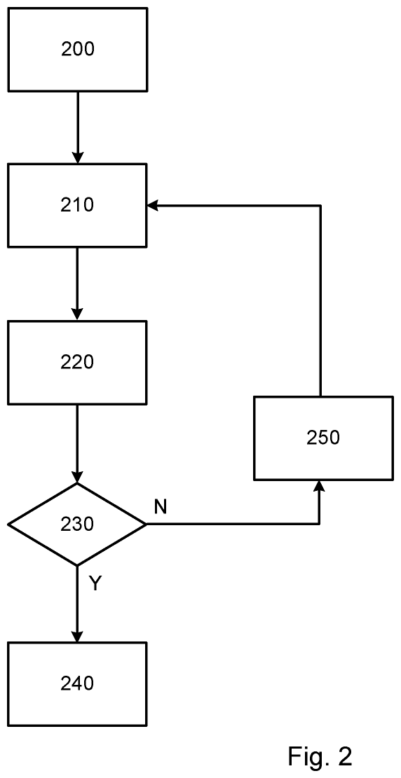

FIG. 2 is a flowchart of the proposed method. At step 200, a micro model design image which is to be evaluated/optimized, is obtained At step 210, the micro model design image is abstracted, e.g., as a pore network. At step 220, performance of the pore network is computationally simulated; for example, fluid flows are computationally simulated within the pore network. Such fluid flows may be two-phase or multi-phase flows which are difficult to simulate using a more complex geometrical representation. This step may comprise using a lattice Boltzmann simulation method, for example. At step 230, an evaluation of the performance of the pore network is made; e.g., does it meet a particular design objective. If so, then the micro model design image from which the pore network has been abstracted can be forwarded for fabrication 240. If not, then the design image can be changed 250 and the cycle repeated in an optimization loop till the design objective is reached.

With regard to the evaluation of step 230, this could be performed in a number of ways depending on the design objective. For example, after the pore network performance simulation, key parameters could be checked. The key parameters could include, for example, one or more of: Pc curve, Sor, oil-water distribution near inlet region, and velocity distribution. If the evaluated key parameter(s) do not match desired value (normally obtained from experiment or defined by specialist knowledge), the micro model pattern design can be changed accordingly. As such, the evaluation may comprise comparing one or more simulated key parameter values to one or more corresponding key parameter reference values (obtained by experiment, specialist knowledge or otherwise) to determine whether they are sufficiently consistent e.g., match at least within a threshold range.

Modifying the micro model according to the key parameters (Step 250) may comprise, for example, one or more of the following:
reducing the throat size/distribution mean, or vice versa if the simulated Pc curve is above a desired Pc;
increasing the aspect ratio between pore and throat is the simulated Sor is lower than a desired Sor:
enlarging the inlet channel sizes and checking the sizes of pores/throats near the inlet region (to ensure sure they are uniform and of appropriate sizes) where the simulated oil/water distribution is not uniform.

These are purely examples and this list is non-exhaustive; many alternative evaluation and modifying approaches are possible and can be envisaged depending on a particular case.

Once optimized, the pore network can also be used to perform other simulation experiments. A physical micro model can only be used a couple of times, so the ability to perform additional experiments without using a physical micro model is beneficial. Additionally, such a simulation enables other parameters (e.g., pressures or strains) within the model to be measured/estimated which cannot otherwise be measured in a physical model. For example, the small size of the model means that the necessary sensors cannot be accommodated within it.

The step 210 may comprise using a pore network extraction algorithm directly on 2D micro model design images, rather than a 3D geometry as described in the aforementioned publications. Such a method may be similar to methods performed on 3D geometry, but with a relieved constraint in the third dimension. Flow simulations (including two-phase/multiphase flow simulations) in such pore networks are relatively simple to solve analytically. Other than this 2D implementation, any suitable pore network extraction method may be used, including those described in the aforementioned incorporated documents.

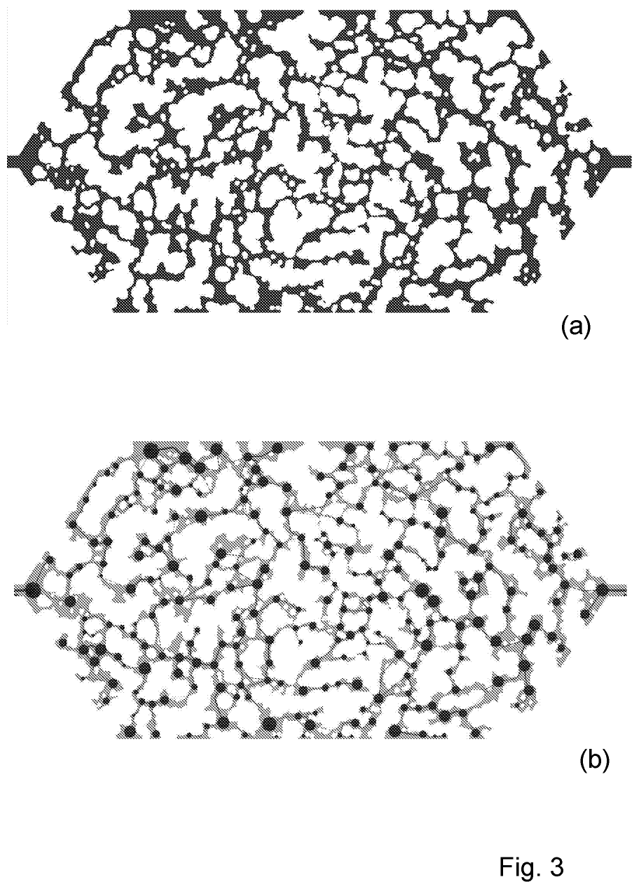

FIG. 3 illustrates the results of such a step. FIG. 3(a) is an illustration of a typical micro model design image and FIG. 3(b) is the same design image with the abstracted pore network overlaid.

As such, a method for designing and fabricating a micro model is described which enables a fast appraisal of micro-model design, optimisation of the micro-model design, better interpretation of experimental results, and the ability to calculate parameters that are difficult to measure within the physical model. Due to the expense of fabrication, only a limited number of micro model patterns can be fabricated. Using the proposed method, a virtually unlimited number of designs and variations can be tested at very little cost, with only the optimised design being selected for fabrication. It is expected that a typical cycle of the flow described in FIG. 2 will take only several minutes on a typical personal computer or laptop.

One or more steps of the methods and concepts described herein may be embodied in the form of computer readable instructions for running on suitable computer apparatus, or in the form of a computer system comprising at least a storage means for storing program instructions embodying the concepts described herein and a processing unit for performing the instructions. As is conventional, the storage means may comprise a computer memory (of any sort), and/or disk drive, optical drive or similar. Such a computer system may also comprise a display unit and one or more input/output devices.

The concepts described herein find utility in all aspects of surveillance, monitoring, optimisation and prediction of hydrocarbon reservoir and well systems, and may aid in, and form part of, methods for extracting hydrocarbons from such hydrocarbon reservoir and well systems.

It should be appreciated that the above description is for illustration only and other embodiments and variations may be envisaged without departing from the spirit and scope of the invention.

1. A method of evaluating a micro model prior to fabrication of the micro model, the method comprising;
obtaining a design document describing a geometry of a proposed micro model;
abstracting the geometry into a simplified representation of said geometry;
computationally simulating performance of the proposed micro model based on the abstracted geometry; and
evaluating the proposed micro model based on the simulation.

2. A method as claimed in claim 1, wherein said abstracting step comprises performing a pore network extraction on said design document, such that said simplified representation comprises a pore network representation of said geometry.

3. A method as claimed in claim 2, wherein said pore network extraction is performed directly on a 2D design document.

4. A method as claimed in claim 3, wherein said pore network extraction is unconstrained in the direction perpendicular to the plane of said geometry described in the design document.

5. A method as claimed in claim 1, further comprising performing computationally simulated flow experiments using the abstracted geometry to obtain additional experimental data without using a physical micro model.

6. A method as claimed in claim 5, wherein said additional experimental data comprises parameter data not measurable within a physical micro model.

7. A method as claimed in claim 1, further comprising optimizing the micro model by changing said geometry of the proposed micro model and repeating the abstracting, computationally simulating and evaluating steps.

8. A method as claimed in claim 7, further comprising repeating the optimizing step until a design objective is reached.

9. A method as claimed in claim 7, further comprising the step of fabricating the optimized micro model.

10. A method of fabricating a micro model, the method comprising;
obtaining a design document describing a geometry of a proposed micro model;
abstracting the geometry into a simplified representation;
computationally simulating performance of the proposed micro model based on the abstracted geometry;
evaluating the proposed micro model based on the simulation;
optimizing the micro model by changing the geometry of the proposed micro model and repeating the abstracting, computationally simulating and evaluating steps until a design objective is reached; and
fabricating the optimized micro model.

11. A method as claimed in claim 10, wherein said abstracting step comprises performing a pore network extraction on said design document, such that said simplified representation comprises a pore network representation of said geometry.

12. A method as claimed in claim 11, wherein said pore network extraction is performed directly on a 2D design document.

13. A method as claimed in claim 12, wherein said pore network extraction is unconstrained in the direction perpendicular to the plane of said geometry described in the design document.

14. A method as claimed in claim 10, further comprising performing computationally simulated flow experiments using the abstracted geometry to obtain additional experimental data without using a physical micro model.

15. A computer program comprising computer readable instructions which, when run on suitable computer apparatus, cause the computer apparatus to perform the method of claim 1.

16. A computer program carrier comprising the computer program of claim 15.
